(19) United States
(12) Patent Application Publication
(10) Pub. No.: US 2014/0190034 A1
(43) Pub. Date: Jul. 10, 2014

(54) HEATER AND DEHUMIDIFIER FOR GAME CALLS

(71) Applicants: WILLIAM F. FARRALL, SR., KING GEORGE, VA (US); WILLIAM F. FARRALL, Jr., KING GEORGE, VA (US); GAIL MARLENE FARRALL, KING GEORGE, VA (US)

(72) Inventors: WILLIAM F. FARRALL, SR., KING GEORGE, VA (US); WILLIAM F. FARRALL, Jr., KING GEORGE, VA (US); GAIL MARLENE FARRALL, KING GEORGE, VA (US)

(21) Appl. No.: 14/133,505

(22) Filed: Dec. 18, 2013

Related U.S. Application Data
(60) Provisional application No. 61/848,711, filed on Jan. 10, 2013.

(51) Int. Cl. F26B 3/04; F26B 25/08

(52) U.S. Cl. CPC F26B 3/04; F26B 25/08
USPC 34/232

(57) ABSTRACT

The heater and dehumidifier for game calls includes a body having a least one main inlet for receiving airflow into the body, an at least one second opening formed in the body defining an at least one main outlet. A first chamber has a first passageway, a second chamber has a second passageway and a third chamber has a third passageway. The first passageway is in communication with the second passageway, and the second passageway is in communication with the third passageway. The device further includes at least one stack adapted to receive a call.

This application claims the benefit of U.S. Provisional Application No. 61/848,711, filed Jan. 10, 2013.

### BACKGROUND OF THE INVENTION

1. Field of the Invention

The invention relates to a heating and dehumidifying device. More particularly, the invention relates to a heater and dehumidifier for game calls and mouthpieces.

2. Description of the Related Art

Game calls are devices used by hunters to attract “game” waterfowl, such as duck and geese, and other animals, for the purposes of hunting them. A game call is activated by the user or hunter, by blowing into the call device, to generate a sound that mimics the sound of an animal. This is done to attract the animal to the hunter's area. One problem commonly encountered with respect to game calls are that during the blowing or “calling” process, moisture can accumulate within the call device. The build-up of moisture in the call, not only affects the sound quality generated by the call, but it also can cause the call to fail. This is not a desirable condition when a hunter is on a hunting expedition.

Cold weather can also be another adverse effect on a game call that is wet. The combination of moisture and cold weather may cause the call to freeze, thereby disabling the device. A malfunctioning call is extremely inconvenient. Currently, the only known solution for frozen calls is to thread a thin piece of paper, such as a dollar bill, through the calls reed and sounding board, or to blow from the opposite end of the call, to remove the moisture. However, by blowing into the tube, through an opposite end of the device, moisture from the user's mouth can actually increase the level of moisture in the device. This method of removing moisture is not desirable. The aforementioned methods for heating and dehumidifying the call are very short term, and in many cases ineffective. Accordingly, there exists a need for a portable device that can advance dry heated air through a game call to remove moisture and dry out the call for further use. Thus, a device for heating and dehumidifying for game calls, solving the aforementioned problems is desirable.

### SUMMARY OF THE INVENTION

The heater and dehumidifier for game calls includes a body having an least one main inlet for receiving airflow into the body, an at least one second opening formed in the body defining an at least one main outlet. A first chamber has a first passageway, a second chamber has a second passageway and a third chamber has a third passageway. The first passageway is in communication with the second passageway, and the second passageway is in communication with the third passageway.

The device further includes at least one stack adapted to receive a call. The stack has an at least one stack inlet in communication with the at least one main outlet of the body, to receive air flow from the inner chamber. The stack has an at least one stack outlet opening in communication with the at least one stack inlet opening to facilitate air flow through the stack. The stack further includes an adapter configured to receive the call.

The device further includes an air driving assembly to facilitate air flow into the body through the at least one first opening formed in the body, a power source to provide power to the air driving assembly, and a heating element provided in the inner chamber to warm air as it passes through the at least one passageway.

The device further includes a controller in communication with the heating element, air driving assembly, power source and thermostat, to enable a user to control the power delivered from the power source to the air driving assembly, and further control the operation time of the device.

These and other features of the present invention will become readily apparent upon further review of the following specification and drawings.

### BRIEF DESCRIPTION OF THE DRAWINGS

FIG. 1 is an environmental, perspective view of a heater and dehumidifier for game calls according to the present invention.

FIG. 2 is a sectional view of the game call heater and dehumidifier device having a singular call stack according to the present invention.

FIG. 3 is a sectional view of the game call heater and dehumidifier device illustrating plural call stacks positioned on the device according to the present invention.

FIG. 4 is schematic view of a controller for controlling the game call heater and dehumidifier.

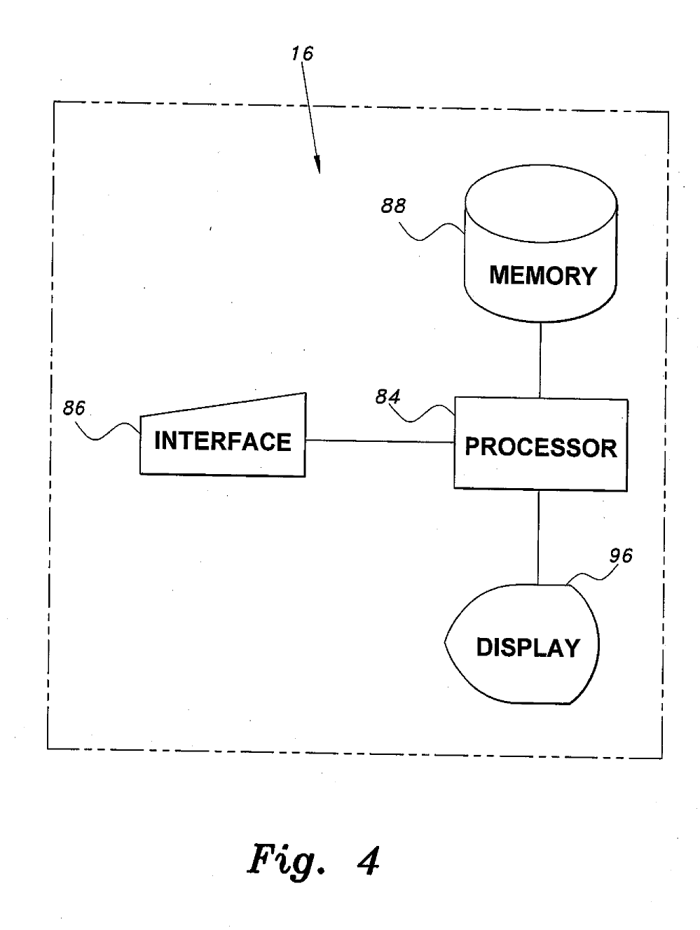

Similar reference characters denote corresponding features consistently throughout the attached drawings.

### DETAILED DESCRIPTION OF THE PREFERRED EMBODIMENTS

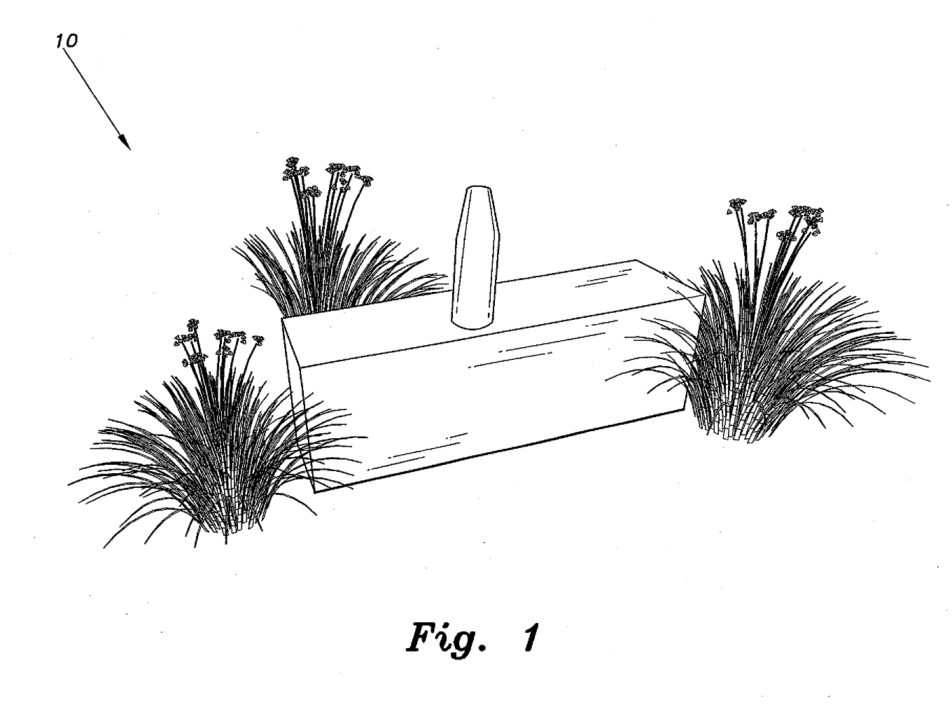

Referring now to FIG. 1 as embodiments of a game call heater and dehumidifier, such as game call and dehumidifier device 10 enables a user to dehumidify and heat one or more game calls, or mouth pieces. The device 10 is portable and configured to operate in indoor or outdoor conditions if desired. While the device 10 is particularly applicable to heating and drying game calls, the heater and dehumidifier can also be used for drying other devices, such as mouth pieces used in musical instruments, or the like, and should not be construed in a limiting sense.

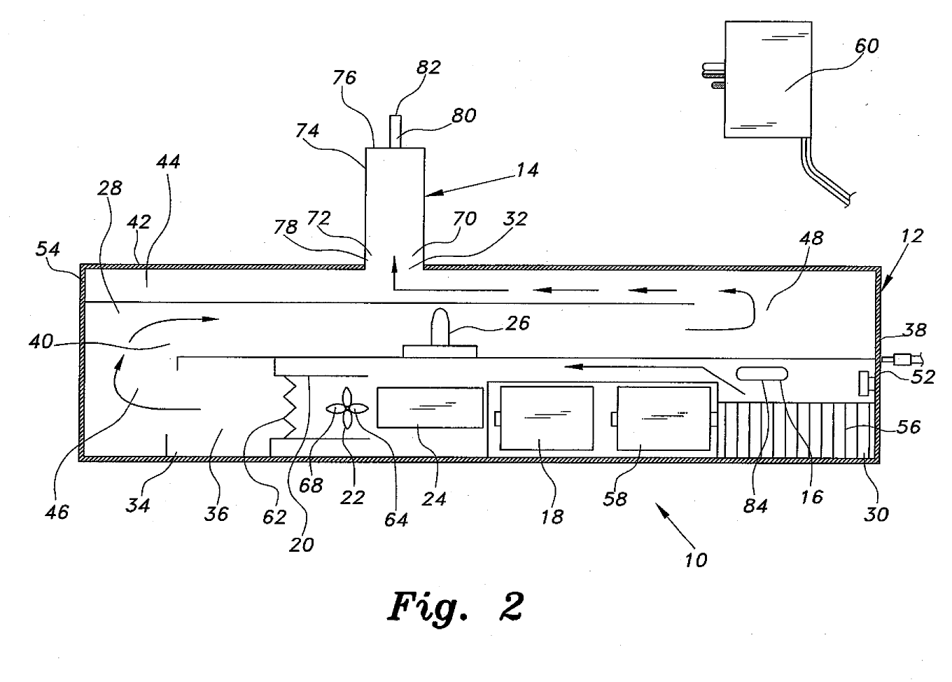

Continuing to FIG. 2, the device 10 generally includes a body 12, one or more call stacks or mounts 14 provided on the body 12, a power source 18 to provide power to the device 10, a heating assembly 20 for heating air as it passes through the device 10, an air driving assembly 22 for driving air into and through the device 10, a thermostat 26, for detecting the temperature of the air delivered to the one or more call stack 14, and a controller 16, which is in communication with the power source 18, air driving assembly 22, heating assembly 20, and thermostat 26, and as such, controls the operation of the device 10.

The body 12 includes an inner chamber 28 that facilitates air flow through the device 10 from one or more inlets 30, to one or more outlets 32. The inner chamber 28 includes a first chamber 34 defining a first passageway 36, a second chamber 38 defining a second passageway 40, and a third chamber 42 defining a third passageway 44.

The first chamber 34 and first passageway 36 is in communication with the second chamber 38 and second passageway 40 via the opening 46. Further, the second chamber 38 and second passageway 40 is in communication with the third chamber 42 and third passageway 44 via the opening 48. The first chamber 34 is provided in a lower portion 52 of the inner chamber 28 of the device 10. The third chamber 42 is positioned in the upper portion 54 of the inner chamber 28 of the device 10. The second chamber 38 is positioned intermediate to the first chamber 34 and the third chamber 42. The chambers 34, 38 and 42 and corresponding passageways 36, 40 and 44, are adapted to receive air flow, such that air can flow through the inlet 30 and outlet 32, and further through the stack 14.

As stated, the main inlet 30 is configured to receive air flow into the device 10. As shown, a vent 56 is provided at the main inlet 30 to facilitate air flow into the chamber 28. The vent 56 is configured to filter foreign objects from entering the first passageway 34 and clogging the main inlet 30. Notably, as it is contemplated that plural main inlets 30 can be provided to the body 12 to facilitate air intake, it is further contemplated that corresponding plural vents 56 can be provided to the body 12. As shown, the vent 56 is provided along a generally lower portion of the body 12, and in communication with the passageway 36 of the first chamber 34.

The power source 18 provides power to the air driving assembly 22, heating assembly 20, controller 16 and thermostat 26. The power source 18 can include one or more batteries 58. It is contemplated that the battery 58 can be one of the numerous types of rechargeable batteries 58 generally known. In addition to providing power to the device 10 the battery 58 can also provide a second heating element 58 that heats the air passing through inner chamber 28. As illustrated, the battery 58 can be positioned along the passageway 36 in the first chamber 28, such that as air flows past the battery 58 the air is heated. As shown the power assembly 18 further includes a power jack 60 connected to the body 12, to charge the battery 58.

The heating assembly 20 includes one more first heating elements 62 for heating the air as it passes through the inner chamber 28. The heating element 62 can be a standard heater such as a core heat, mini heater, mini coils, a light bulb, or any other type of heater suitable for heating the air flow as it travels down the passageway 36. As shown, the heater is positioned in the first passageway 36 to provide heating to a desired temperature. However it is contemplated that the heating elements 62 can also be located in a second passageway 40 or the third passageway 44, without departing from the scope of the invention. It is further contemplated that plural heating elements 62 may be provided, and positioned in the inner chamber 28.

The air driving assembly 22 facilitates air flow through the first passageway 36 and through the body 12. The air driving assembly 22 may include a fan or vacuum 64. In the case of the fan 64, the fan 64 includes a motor 24 that converts power from the power source 18 into movement of the fan 64. Notably, the fan 64 can be a mini fan, or any type of device capable of drawing air into the inner chamber 36. The fan 64 can include a rotating arrangement of vanes or blades 68 which act on the air. The rotating assembly 68 of blades and hub is known as an impeller, a rotor, or a runner. It is contemplated that plural fans 64 can be positioned in the device to facilitate air flow through multiple locations in the body 12, such as the second passageway 40 and the third passageway 44.

The thermostat 26 is provided in the inner chamber 28 to detect the temperature of the air flowing through the inner chamber 28, prior to entering the stack 14. The thermostat 26 is in communication with the controller 16 and sends a signal to the controller 16 to increase or decrease the temperature of the air traveling through the chamber 28 by turning the first heating element 62, on and off. As shown in the drawings, the thermostat 26 is provided in the second passageway 40 of the second chamber 38, however, notably, the thermostat 26 can also be provided in the first passageway 36, or the third passageway 44, without departing from the scope of the invention.

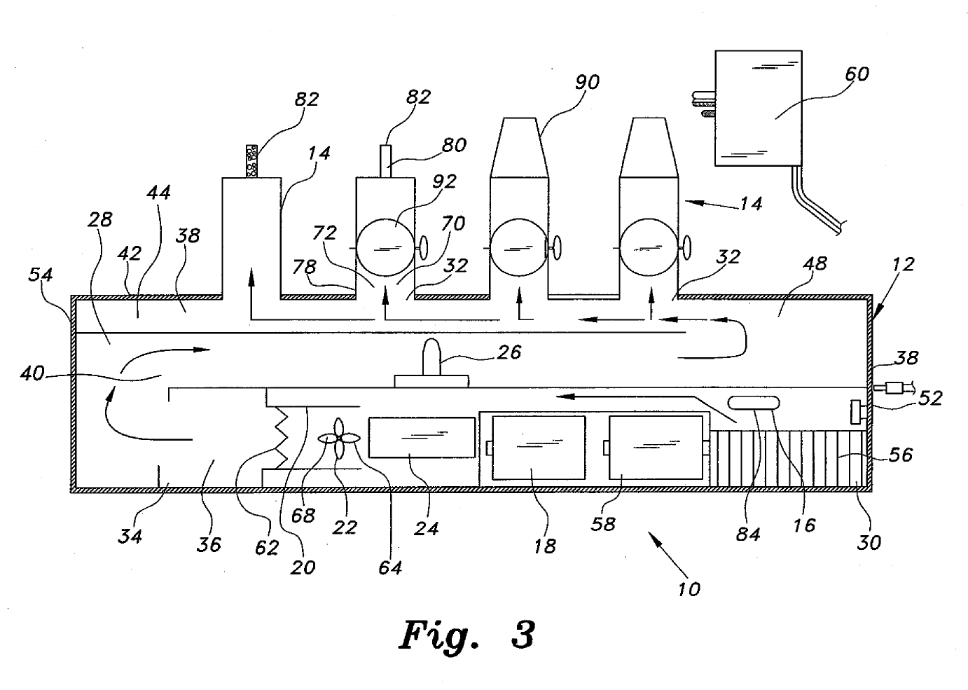

As shown, the second chamber 38 is positioned generally above the first chamber 34 in the device 10. The third passageway 44 is in communication with one or more stacks 14. As illustrated, the call stack 14 is positioned in a generally longitudinally manner relative to the body 12 extending generally upward therefrom. The mounting assembly is positioned along the body and is in communication with the inner chamber of the body to provide air flow. The device 10 includes at least one stack adapted to receive a corresponding call thereon. As illustrated in FIG. 3, the stack 14 includes a body 72 having an upper portion 74 configured to receive a lip 76 and a lower portion 78 aperture 70 formed in communication with the outlet 32 of the body 12 to enable air flow therethrough.

The stack 14 has an adapter or tip 80, which extends generally outward from the stack body 72 of the stack 14. The adapter 80 is adapted to receive the call. As such, the adapter 80 can be a narrow tubular tip, having a circumference ranging between ⅛ inch to ½ inch. The adapter 90 may also be a fluted tip 90 adapted to fit calls that have a larger barrel diameter.

The stack 14 further has an opening defining an inlet in communication with a corresponding body main outlet to receive air flow therethrough. Further, the stack 14 includes one or more apertures 82 defining an outlet to enable air flow from the stack 14 into the call. As illustrated in FIG. 3, the device 10 can provide plural stacks 14, to dehumidify and dry multiple calls simultaneously. As such, the device 10 provides plural main outlets 32 formed on the body 12. The plural main outlets 32 are in communication with the plural stacks 14 corresponding inlets enabling air distribution to the multiple calls.

As illustrated, the aperture 82 is formed at the generally end of the stack 14, however notably it is contemplated that plural apertures 82 can be formed along the outer body 72 of the stack 14, to enable air distribution into the adapter 80, 90 through the stack 14. The stack 14 further includes a baffle 92 provided in the body 72 of the stack 14. The baffle 92 enables a user to selectively open and close the stack 14 to prevent the flow through the stack 14.

The controller 16 is in communication with the power assembly 18, air driving assembly 22, heating assembly 20, and thermostat 26 to control operation of the device 10. The controller 16 can include a processor 84, and memory 88, to control the air driving assembly 22 and heating assembly 20. The processor 84 provides a programmable timing device, enabling the user to selectively program the desired operation time. The 16 controller further enables a user to control the temperature by inputting the desired operating temperature and operating time through the interface 86. The controller 16 further includes a computer display 96 for displaying information.

Data may be stored in computer readable memory 88, which may be any suitable type of computer readable and programmable memory. It should be understood that the controller 16 may represent, for example, a portable computing device, a cell phone, a PDA, or networked portable device. This information may be displayed to the user on the display 96, which may be any suitable type of computer display 96. The processor 84 may be associated with, or incorporated into, any suitable type of computing device, for example, a programmable logic controller.

In operation, the user switches on the device 10 using the interface 86 in communication the controller 16. Notably it is contemplated that the device 10 can also be activated remotely using Bluetooth, wireless providing for remote communication. Activation of the device turns on the power source 18 and the motor 24 and operatively connected fan 64 creating a vacuum that pulls air flow into the body 12 and inner chamber 24 through first opening 30.

As illustrated the air enters through the inlet 30 and through one or more vents 56. As the air travels, it enters the first passageway 36. As shown, air flows past the power source 18 or batteries 58. As the air travels past the batteries 58, the batteries emit heat which is transferred to the air, warming the air. The air travels past the fan 64 and contacts the heating element 20 the air is warmed by the heating element 20. As shown, the air travels past and the through the opening 46 and into the second passageway 40 formed in the second chamber 38.

The thermostat 26 detects the temperature of the air and sends a signal to the controller 16. After the air passes through the second passageway 40, it enters into a third passageway 44 and is distributed through the one or more stacks 14, located in the third chamber 42. The baffle 92 in a generally open position enables air flow through the stack 14 and through the one or more openings 82 thereby providing heat to a connected call. To shut off the device 10, the user can select to shut off the device using the interface 86 or via the controller 16 using a set timer.

It is to be understood that the present invention is not limited to the embodiments described above, but encompasses any and all embodiments within the scope of the following.

We claim:

1. A device for dehumidifying and drying game calls, comprising:
a body having an inner chamber, and at least one first opening formed in the body defining an at least one main inlet for receiving airflow into the body, an at least one second opening formed in the body defining an at least one main outlet, and an at least one passageway formed in the inner chamber, to enable communication between the at least one first opening and the at least one second opening;
at least one stack adapted to receive a call, the stack having an at least one stack inlet in communication with the at least one main outlet of the body, to receive air flow from the at least one passageway, the stack having an at least one stack outlet opening in communication with the at least one stack inlet opening to facilitate air flow through the stack, the stack having an adapter configured to receive a call;
an air driving assembly to facilitate air flow into the body through the at least one first opening formed in the body;
a power source to provide power to the air driving assembly;
wherein when the device is turned on, the air driving assembly drives air through the main inlet of the body, through the at least one passageway, through the at least one stack and through at least one stack outlet to provide drying air to a call:

2. The device of claim 1, further comprising a heating element provided in the inner chamber to warm air as it passes through the at least one passageway.

3. The device of claim 1, further comprising a controller to control the power delivered from the power source to the air driving assembly.

4. The device of claim 3, wherein the controller provides a processor and interface to enable a user to selectively program the device to operate for a selected time duration.

5. The device of claim 1, wherein the air driving assembly comprises a fan and a motor to facilitate air flow through the at least one passageway.

6. The device of claim 1, wherein a thermostat is located in the inner chamber to detect the temperature of the air passing through the at least one passageway.

7. The device of claim 1, wherein the inner chamber includes a first chamber defining a first passageway, a second chamber defining a second passageway, and a third chamber defining a third passageway, wherein the first passageway is in communication with the second passageway and the second passageway is in communication with a third passageway.

8. The device of claim 5, wherein the first chamber is positioned in a lower portion of the inner chamber, the third chamber is positioned in an upper part of the inner chamber and the second chamber is positioned in the inner chamber, intermediate to the first chamber and the second chamber.

9. The device of claim 3, wherein the thermostat is provided in the second chamber for detecting the temperature of the air prior to distribution.

10. The device of claim 3, wherein the heating element is provided in the first chamber and first passageway after the air driving assembly.

11. The device of claim 3, wherein the power source is provided in the first chamber.

12. The device of claim 1, wherein the stack includes a baffle disposed therein to open and close the stack.

13. The device of claim 1, wherein the at least one stack includes a plurality of stacks, and the at least one main outlet includes a plurality of main outlets in communication with the corresponding plurality of stacks.

14. The device of claim 1, wherein the power source is a battery provided in the first chamber.

15. The device of claim 1, wherein the first heating element is a light bulb.

16. The device of claim 1, wherein the first heating element is a heating coil.

17. The device of claim 1, where in the power source includes a rechargeable battery.

18. The device of claim 1, wherein the at least one stack has plural outlets formed about the stack to enable air flow out of the stack in plural locations.

19. A device for dehumidifying and heating up and drying mouthpieces, comprising:
a body having an least one main inlet for receiving airflow into the body, an at least one second opening formed in the body defining an at least one main outlet.
a first chamber defining a first passageway, a second chamber having a second passageway and a third chamber having a third passageway; the first passageway being in communication with the second passageway and the second passageway being in communication with a third passageway.
at least one stack adapted to receive a mouthpiece, the stack having an at least one stack inlet in communication with the at least one main outlet of the body, to receive air flow from the at least one passageway, the stack having an at least one stack outlet opening in communication with the at least one stack inlet opening to facilitate air flow through the stack, the stack having an adapter configured to receive a mouthpiece;
an air driving assembly to facilitate air flow into the body through the at least one first opening formed in the body;
a power source to provide power to the air driving assembly;
a heating element provided in the inner chamber to warm air as it passes through the at least one passageway;
a controller to controls the power delivered from the power source to the air driving assembly;
and, a thermostat is located in the inner chamber to detect the temperature of the air passing through the at least one passageway.
